(19) United States
(12) Patent Application Publication
(10) Pub. No.: US 2025/0198900 A1
(43) Pub. Date: Jun. 19, 2025

(54) PERMEABILITY MEASUREMENT DEVICE AND METHOD

(71) Applicant: CENTRE NATIONAL DE LA RECHERCHE SCIENTIFIQUE, Paris (FR)

(72) Inventors: Jean CACHEUX, Tokyo (JP); Aurélien BANCAUD, Tokyo (JP); Yukiko MATSUNAGA, Tokyo (JP); Laurent JALABERT, Bessieres (FR)

(21) Appl. No.: 18/836,295

(22) PCT Filed: Feb. 7, 2023
(86) PCT No.: PCT/EP2023/053024

§ 371 Date: Aug. 6, 2024

(30) Foreign Application Priority Data
Feb. 8, 2022 (FR) FR2201116

(51) Int. Cl. G01N 15/08; G01N 15/01

(52) U.S. Cl. CPC G01N 15/0826; G01N 15/0806; G01N 15/01

(57) ABSTRACT

A device for measuring the permeability of a porous material to a fluid includes an air cavity, a material module including a support configured to contain a volume of fluid, and the porous material. The air cavity and the support are arranged such that the porous material is between the volume of fluid and the air cavity. The device includes means for measuring the pressure in the air cavity over time, means for controlling the pressure of the volume of fluid, which are configured to apply a pressure to the volume of fluid so as to induce a flow through the porous material in the air cavity, and digital means configured to determine the pressure gradient between the volume of fluid and the air cavity, the flow rate of the fluid through the porous material, and the permeability of the porous material.

The present application is a U.S. National Phase of International Application Number PCT/EP2023/053024, filed Feb. 7, 2023, which claims priority to French Application No. 2201116, filed Feb. 8, 2022.

### TECHNICAL FIELD

The present invention relates to a device for measuring the permeability of a material porous to a fluid. The invention also relates to a method using such a device.

The field of the invention is, non-limitatively, that of characterising media and materials.

### PRIOR ART

In biology, the permeability of a material, such as a cell tissue, is a quantity central for exchange mechanisms. This is because the matrices of the tissues are porous to fluids and a hydrostatic pressure is maintained by the blood pressure towards the lymphatic system. Permeability is regulated by the interface cell tissues (called endothelium or epithelium) that form barriers to flows. A stronger resistance to flow is represented by a lower permeability coefficient.

To know the permeability of a medium or a material to a fluid, it is necessary to determine the ability of this medium or material to have the fluid pass through it under the effect of a pressure difference on either side of this medium or material. Permeability measurement appliances are called “permeameters”. In the context of biological materials, for example body tissues, permeability is coupled to the mechanical properties of the material; poromechanics is then spoken of.

Determining the permeability of a medium or material requires measuring the flow rate of the fluid through this material and the pressure gradient along the direction of this flow.

In the tools for characterising interstitial flows of cell matrices, these two quantities are rarely known simultaneously.

Methods for measuring the permeability of cell tissues are summarised, for example, in the articles “Transport of Molecules in the Tumour Interstitium: A review”, Cancer Res 47: 3039 and “Measurement of interstitial fluid pressure: Comparison of Methods” Annals Biomed Engineering 14: 139.

Methods are also known measuring the flows of liquids through cell media or barriers, in particular following the movement dynamics of fluorescent tracers, which attest to the speed of a flow.

Finally, electrical methods can be used for characterising barriers, such as the one measuring transepithelial electrical resistance (TEER), making it possible to measure an ionic flow with zero pressure.

These two approaches thus measure the permeability to macromolecules or ions. When it is a case of characterising permeability to a fluid, there are in particular methods measuring the local pressure in the tissues, such as that of “wick-in needle”, corresponding to a needle pricked in a target zone of the body and equipped with an offset pressure sensor. In other cases, a measurement of fluid flow is made by means of flowmeters. The methods and tools mentioned do however not make it possible to directly measure both the flow rate and the pressure gradient through the medium or material, using a single measurement means.

In the materials field, in particular construction, other tools are known for measuring permeability. For example, the permeability of concrete to a fluid can be determined by means of a Blaine permeability meter as described for example in J.P. Ollivier, M. Massat, “Permeability and microstructure of concrete: a review of modelling”, Cement and Concrete Research, Volume 22, 1992, pages 503-514. The Blaine permeability meter allows such measurement with a pressure sensor coupled to a low-rate sensor.

The object of the invention is to propose a device and a method for measuring the permeability of a porous material that can overcome these drawbacks.

### DESCRIPTION OF THE INVENTION

One aim of the present invention is to propose a device and a method for determining the permeability of a porous material making it possible to directly measure the pressure gradient and the flow rate of a fluid through the porous material.

Another aim of the present invention is to propose a device and a method for determining the permeability of a porous material the use of which makes it possible to easily measure various types of material and to be adapted to a scanning of experimental conditions with a single measurement.

Yet another aim of the present invention is to propose a device and a method for determining the permeability of a porous material the implementation of which can be automated.

At least one of these aims is achieved with a device for measuring the permeability of a material porous to a fluid, the device comprising:
an air cavity of a specific volume;
a material module, the material module comprising:
   a support configured to contain/convey a volume of fluid, and
   the porous material;

wherein the air cavity and the support are arranged so that a specific thickness H of the porous material is located between the volume of fluid and the air cavity, a wall of the air cavity being partially formed by the porous material;

the device furthermore comprising:
a pressure sensor or means for measuring the pressure P_{C} in the air cavity as a function of time;
a pressure controller or means for controlling the pressure of the volume of fluid configured to apply a fluid pressure P_{B} so as to cause a flow of fluid through the porous material to the air cavity;
a digital device, also called digital means, configured to:
   determine the pressure gradient between the volume of fluid and the air cavity, ∇P=(P_{B}−P_{C})/H;
   determine the flow rate of the fluid through the porous material from the drift over time in the pressure of the air in the cavity, dP_{C}/dt; and.
   determine the permeability of the porous material from the flow rate and from the pressure gradient ∇P.

The measuring according to the device invention can be considered to be a permeameter, i.e. an appliance for measuring permeability. The response of the device can be considered to be that of a capacitor. This means that the application of the pressure to the volume of fluid is not done in permanent regime. Thus it is possible to obtain a response curve of the permeability as a function of the pressure gradient with a single application of pressure to the volume of fluid.

Advantageously, the device according to the invention makes it possible to directly measure the flow rate of the fluid through the porous material and the pressure gradient applied material. The to this permeability of the material measured can be immediately deduced from these two quantities.

The device according to the invention furthermore allows integration of the pressure sensor that is very simple and easy to implement. A standard sensor available commercially can be used in the device.

In fact the pressure sensor can be offset at a distance from the air cavity. According to one example, the pressure sensor can be connected to the air cavity with a tube of known volume.

Thus the same pressure control means, such as a single pressure controller, can be used for a plurality of material-module/air-cavity assemblies.

The device according to the invention being compatible with cell incubation conditions, it is for example possible to make measurements with the device according to the invention in an incubator in the context of tissue engineering, in particular for manufacturing organs on chip. The measurements and the pressure control are made remotely.

The device according to the invention is easily adaptable to the design of organs on chip.

Furthermore, the device according to the invention can be used with a plurality of different types of porous material. For example, all types of cell tissues, with or without barrier layer, or other porous materials, such as polymer films or concretes, can be measured with the device according to the invention.

The fluid may be a liquid or a gas, for example water or air.

According to one embodiment, the digital means can furthermore be configured to determine the modulus of elasticity of the porous material from the pressure gradient between the volume of fluid and the air cavity as a function of time.

In engineering, a material can be characterised by its Young's modulus, or modulus of elasticity, and its Poisson's ratio.

It is possible, from the measurement of the pressure in the cavity as a function of time, to access both the mechanical and hydrodynamic properties of the material using the differentiated kinetics of the pressure response. When a hydrostatic pressure is applied to the material, the material is subjected to a deformation, contributing to the increase in pressure in the air cavity due to the permeability of the material. These two mechanisms have very different timescales, enabling the pressure gradient to be analysed.

The amplitude of the deformation increases as the elasticity of the material increases, corresponding to a decreasing Young's modulus. The Poisson's ratio makes it possible to characterise the contraction of the material perpendicularly to the direction of application of the hydrostatic pressure, this contraction being due to structural reorganisations of the material. For a given Young's modulus, the Poisson's ratio has an influence on the first times of the deformation response dynamics.

According to an advantageous embodiment, the volume of fluid can be contained partially in microchannel passing through the porous material.

The support can also comprise a system of channels and reservoirs in which the volume of fluid is contained and This conveyed. system is in fluid communication with the microchannel.

According to one example of implementation, the support can be made from silicone, and in particular of the polydimethylsiloxane (PDMS) type.

PDMS has advantageous properties. It is in particularly chemically inert, non-toxic and transparent.

To be able to make selective flow measurements through the layer of porous material, it is necessary for there to be no interstices at the material/support interfaces, in order to guarantee impermeability at the interfaces. For this purpose, a sealed join between the two materials is provided for implementing the material module.

According to a first example of implementation, the porous material can be glued to the support permanently.

Permanent gluing is in particular adapted when the porous material is collagen. The latter is in fact very soft and fragile, and gluing to the support represents a non-damaging securing means.

According to another example of implementation, the porous material can be held by clamping to the support, with isolating joints at the material/support interface.

According to another aspect of the same invention, a method is proposed for measuring the permeability of a material porous to a fluid, wherein a given thickness H of the porous material is arranged between an air cavity of a given volume and a volume of fluid, a wall of the air cavity being partially formed by the porous material, the method comprising the following steps:
applying a pressure P_{B} to the volume of fluid so as to cause a flow through the porous material to the air cavity;
measuring the pressure P_{C} in the air cavity as a function of time;
determining the pressure gradient between the volume of fluid and the air cavity, ∇P=(P_{B}−P_{C})/H;
determining the flow rate of the fluid through the porous material from the drift over time in the pressure of the air in the cavity, dP_{C}/dt; and
determining the permeability of the porous material from the flow rate and pressure gradient ∇p.

The method according to the invention makes it possible to determine the permeability of a porous material, i.e. its ability to allow itself to be passed through by a fluid under the effect of a pressure gradient.

The method according to the invention makes it possible to directly measure the flow rate of fluid through the porous material and the difference in pressure on either side of this material. The permeability of the material measured can be deduced immediately from these two quantities.

According to one embodiment, the method can furthermore comprise a step of determining the modulus of elasticity of the porous material from the pressure gradient between the volume of fluid and the air cavity (4), ∇P, as a function of time.

Advantageously, measuring the pressure in the cavity can be done by means of a remote pressure sensor connected to the air cavity.

Alternatively, measuring the pressure in the air cavity can be done by means of a pressure sensor in the immediate vicinity of the cavity.

According to one embodiment, measuring the pressure in the cavity can be done at regular intervals from the start of the application of the pressure, P_{B}, to the volume of fluid.

The frequency of the pressure measurement in the cavity can be adapted according to the barrier of the porous material.

According to one embodiment, the method according to the invention can furthermore comprise a prior preparation phase. The preparation phase can comprise the following steps:
providing a material support, the air cavity and the porous material, the support being configured to contain/convey a volume of fluid;
applying a porous material to the support;
disposing the air cavity on the material;
providing means for measuring the pressure in the air cavity; and
providing means for controlling the pressure of the volume of fluid.

This preparation phase makes it possible to use the measuring device according to the invention with the material the permeability of which it is wished to measure. A new material module, comprising the support and the porous material, must be prepared for each new measurement. This is because, to be able to make selective flow measurements through the layer of porous material, it is necessary to be able to guarantee impermeability at the interfaces. For this purpose, a sealed join between the two materials is provided for preparing the material module.

For this purpose the support of a previous measurement can be reused by disposing thereon a new porous material to be measured. This is in particular indicated for strong materials that can be secured to the support removably, for example by clamping.

Alternatively, a new support must be used for each new porous material to be measured in the case where the material must be secured to the support permanently, for example by gluing.

The connection piece with the air cavity can be reused with several different material modules, this piece being secured to the material module interchangeably.

### DESCRIPTION OF THE FIGURES AND EMBODIMENTS

Other advantages and features will emerge from the examination of the detailed description of in no way limitative examples, and from the accompanying drawings, on which:

FIG. 1 is a schematic representation, in an exploded view, of a non-limitative example embodiment of a measuring device that can be used in the context of the present invention;

FIG. 2 is a partial schematic representation in cross section of the measuring device of

FIG. 3 is a schematic representation of a partial cross section of a layer of porous material through which a microchannel passes, implemented in a device according to one embodiment of the invention;

FIG. 4 is a schematic representation, in an exploded view, of another non-limitative example embodiment of a measuring device that can be used in the context of the present invention;

FIG. 5 is a schematic representation of a non-limitative example embodiment of a measuring method according to the invention;

FIG. 6 is an example of measurement of flow rate obtained with the present invention;

FIG. 7 is an example of pressure measurement obtained with the present invention;

FIG. 8 is another example of pressure measurement obtained with the present invention;

FIG. 9 is yet another example of pressure measurement obtained with the present invention; and

FIG. 10 is yet another example of pressure measurement, for various porous materials, obtained with the present invention.

Naturally the embodiments that will be described hereinafter are in no way limitative. It will be possible in particular to imagine variants of the invention comprising only a selection of features described hereinafter isolated from the other features described, if this selection of features is sufficient to confer a technical advantage or to differentiate the invention with respect to the prior art. This selection comprises at least one preferably functional feature without structural details, or with only part of the structural details if this part only is sufficient for conferring a technical advantage or for differentiating the invention with respect to the prior art.

In particular all the variants and all the embodiments described can be combined with each other if nothing opposes this combination on a technical level.

On the figures, the elements common to several figures can keep the same reference.

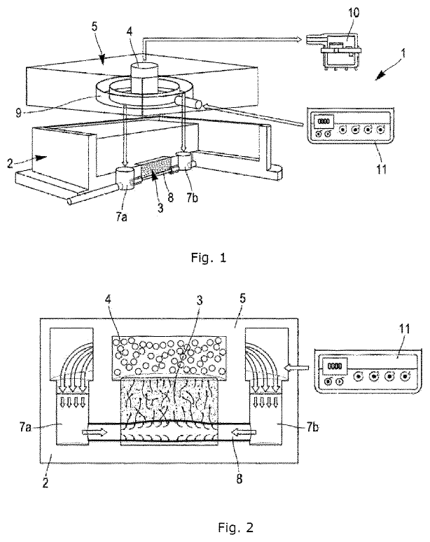

Embodiments of a measuring device that can be used in the context of the present invention will be described hereinafter with reference to FIGS. 1, 2 and 4. FIG. 1 is a semi-exploded schematic view of an example of a measuring device. FIG. 2 is a view in partial cross section of the measuring device of FIG. 1. FIG. 4 is a schematic view of another example of a measuring device.

The device 1, as shown in the embodiment in FIGS. 1 and 2, comprises a support 2 in which a layer of porous material 3 and an air cavity 4 are arranged. The assembly including the support 2 and the layer of porous material 3 can be considered to be a material module. The layer of porous material 3 is glued at its location provided in the support 2, through the bottom surface of the layer.

Preferably, the support 2 is made from polydimethylsiloxane (PDMS). Naturally other materials, in particular polymers, can be used for the support 2.

The device 1 furthermore comprises a cavity 4 containing air. In this example shown on FIGS. 1 and 2, the air cavity 4 is produced in a connection piece 5. The connection piece 5 can be a 3D-printed piece, or a machined piece. The air cavity 4 has a given volume. One of the walls of the air cavity 4 is formed by the layer of porous material 3.

In the example implementation of the device 1 shown on FIGS. 1 and 2, the support 2 includes a channel system for containing and conveying a volume of liquid to the layer of porous material 3. The channel system comprises two lateral channels 7a, 7b that are in fluidic communication with a microchannel 8 and the air cavity 4.

The microchannel 8 is produced by passing a needle through the porous material. In the case of collagen, the needle is inserted while the collagen is in gel form. The gel is next crosslinked and, when the collagen gel becomes solid, the needle is removed, making it possible to create the passage for the fluid.

After the needle is removed, a channel 8 remains through the layer of porous material 3, close to the side opposite to the side adjacent to the air cavity 4. A significant thickness of the layer of porous material 3 is thus located between the air cavity 4 determined and the fluid in the microchannel 8. It is the thickness H of the layer 3 between the microchannel 8 and the air cavity that is considered for determining the permeability of the porous material.

The liquid is for example water.

The connection piece 5 comprises a second cavity 9 through which a pressure P_{B} can be applied to the volume of fluid. In the example implementation shown on FIGS. 1 and 2, this cavity 9, referred to as a control cavity, has an annular shape and is arranged around the air cavity 4.

In order to control the pressure in the control cavity 9, the device 1 comprises pressure control means, such as a pressure controller 11.

The device 1 according to the invention also comprises pressure measurement means. They are in particular used for measuring the pressure P_{C} in the air cavity 4. The pressure measurement means comprise a remote pressure sensor 10. The pressure sensor 10 can be connected to the air cavity 4 with a tube (not shown) with a calibrated volume. The volume of the tube is then added to that of the air cavity 4.

The pressure controller 11 and the pressure sensor 10 can be interfaced by adapted software, of the Labview type (registered trade mark of the company National Instruments), to implement the pressure control and the acquisition of pressure measurements.

The device also comprises digital means for determining the permeability of the porous material 3. These digital means comprise at least one computer, a central or computing unit, a microprocessor, and/or adapted software means.

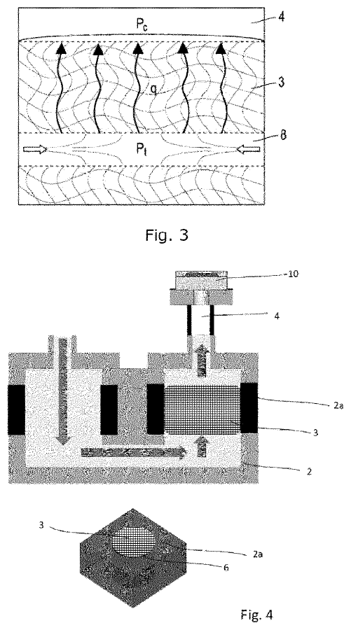

Thus, when the device 1 is used for measuring the permeability of the porous material 3, a pressure P_{B} is applied by the control means to the volume of fluid, controlling the pressure Pc in the control cavity 9. FIG. 3 shows a partial cross section of a layer of porous material 3 through which a microchannel 8 passes, the bottom surface of the layer of material 3 being secured to its support (not shown). When the pressure P_{B} in the control cavity is increased, a flow of fluid located in the system of channels and in the microchannel 8 is caused to pass through the porous material 3 and to the air cavity 4. The flow of fluid can be characterised by its speed of flow, q. The volume of air in the air cavity 4 will then decrease, and the pressure P_{C} of the air increase. By measuring the variation in the pressure in the air cavity 4 as well as the flow rate of the fluid, the permeability of the porous material 3 can be determined.

Another embodiment of the device according to the invention is shown on FIG. 4. The device 1 also comprises a support 2 in which a layer of porous material 3 and an air cavity 4 are arranged. The layer of porous material 3 is neither glued nor placed on the support 2. The material 3 is suspended by these lateral edges in a perforation 6 of a support piece 2a. Preferably, the material 3 is in the form of a membrane that is clamped on its edges in the perforation 6. The bottom surface and the top surface of the material 3 are therefore free to move. The support piece 2a is positioned in the support 2 so that a liquid can flow through the material 3 to the air cavity 4. A pressure sensor 10 closes the air cavity 4. The support piece 2a is removable, facilitating the placing of other materials in the device 1.

To avoid variations in temperature that can cause changes in air pressure in the cavities, the device can be provided with a protective housing, for example a plastic housing. This makes it possible to guarantee the stability and uniformity of the temperature in the device.

The device 1 according to the embodiments shown on FIGS. 1, 2 and 4 can be used for implementing the steps of a determination method that will be described hereinafter.

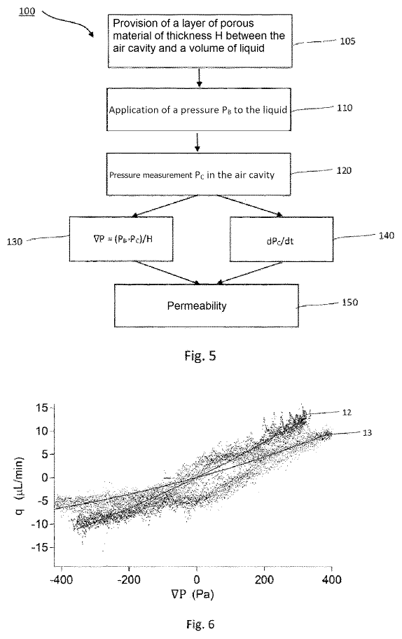

FIG. 5 is a schematic representation of a non-limitative example embodiment of a method for a porous material determining the permeability of according to the invention.

The method 100, shown on FIG. 5, comprises a preparation step 105 during which the layer of porous material the permeability of which is to be determined is placed between an air cavity and a volume of fluid. The layer of material has a known thickness H. For this purpose, the layer of porous material is placed in a support so that the air cavity is located directly on one side of the layer and the fluid on the other side. This positioning can be implemented by means of a material module and a connection piece 5 as described above with reference to FIGS. 1 and 2. Next, means for measuring the pressure in the air cavity and for controlling the pressure applied to the fluid can be provided, as described above.

This preparation step 105 makes it possible to place the measuring device with the required material. The device 1 can be as described with reference to FIGS. 1 and 2. The connection piece 5 with the air cavity can be reused with other material modules. The connection piece 5 is secured to the material module interchangeably. Seals such as conventional rubber toruses can be used for implementing this assembly. When the porous material is collagen or another fragile material of this type, the material module must be prepared anew for each new measurement of a porous material since the collagen must be glued to the support. Other porous materials can be removed from the support, the latter therefore being able to be reused.

The method 100 comprises a step 110 of applying a pressure P_{B} to the volume of fluid. The pressure in the control cavity 9 can in particular be controlled so that it increases to a given value. Thus the pressure P_{B} in the microchannel 8 in the layer of porous material 3 increases and fluid passes through the porous material and accumulates in the air cavity 4.

When the fluid is a liquid, the volume of air in the air cavity 4 decreases and consequently the pressure of the air in the cavity 4 increases as a function of the flow through the layer of porous material.

When the fluid is a gas, the number of component molecules of the air already present in the cavity and of the gas (which may also be air) increases in the cavity, and therefore the pressure therein.

In a measuring step 120, the pressure P_{C} in the air cavity 4 is measured as a function of time.

From the measurement of the pressure P_{C} in the air cavity, the pressure gradient between the volume of fluid and the air cavity can be determined in a step 130. This pressure gradient is expressed as follows:

$$∇ P = \frac{( {P}_{B} - {P}_{C} )}{H} \qquad [ Math . 1 ]$$

Simultaneously, the flow rate of the fluid through the porous material can be determined, in a step 140 of the method, from the drift over time in the pressure of air Pc in the cavity, dP_{C}/dt.

The quantity of fluid passing through the material during an interval of time dt is equal to qSdt, with S the surface area of the microchannel in the porous material and q the speed of flow of the fluid. The coefficient of compressibility of the air, at constant temperature t, can be defined as follows:

$$β - \frac{1}{V} ( \frac{\partial V}{\partial P} ) \text{?} \qquad [ Math . 2 ]$$

$$\text{?} \text{indicates text missing or illegible when filed}$$

In the case of a unidirectional flow with a low Reynolds number, the coefficient of permeability κ is defined with Darcy's law.

$$q = - \frac{κ}{\text{?}} \frac{dP}{\text{?}} , \qquad [ Math . 3 ]$$

$$\text{?} \text{indicates text missing or illegible when filed}$$

with μ the coefficient of viscosity of the fluid and dP/dx=(P_{B}−P_{C})/H the pressure gradient. The coefficient μ characterises the viscosity of the fluid (for example 0.001 Pa.s for water). It is deduced from this that

$${dP}_{C} = - \frac{1}{β} \frac{dV}{{V}_{C}} = \frac{1}{β} \frac{qSd \text{?}}{{V}_{C}} = \frac{1}{β} \frac{\text{?}}{{V}_{C}} \frac{κ}{μ} \frac{( P \text{?} {P}_{C} )}{H} dt . \qquad [ Math . 4 ]$$

$$\text{?} \text{indicates text missing or illegible when filed}$$

The drift over time of the pressure P_{C} in the cavity is then written

$$\frac{{dP}_{C}}{dt} = \frac{1}{β} \frac{\text{?}}{{V}_{C} H} \frac{κ}{μ} ( {P}_{B} - {P}_{C} ) \text{?} \qquad [ Math . 5 ]$$

$$\text{?} \text{indicates text missing or illegible when filed}$$

The factor β is the compressibility of air at ambient temperature, and V_{C} is the volume of the air cavity. This volume V_{C} can be adjusted according to the flow rate of fluid that it is expected to measure. In this embodiment and by applying an input pressure P_{M} it is possible to integrate the mechanical deformation of the material with the variation in pressure in the cavity with a simplified one-dimensional model:

$$P ( H , t ) = {P}_{M} ( 1 - 2 \sum \text{?} \frac{sin ( 2 λ \text{?} ) \text{?}}{sin ( 2 λ \text{?} ) + 2 λ \text{?}} ) \text{?} \qquad [ Math . 6 ]$$

$$\text{?} \text{indicates text missing or illegible when filed}$$

With τ=μH²/κM and λₙ the roots of the equation αλₙtan (λₙ)=1, with α=βV_{C}M/SH. M is defined as the modulus of elasticity of the one-dimensional material.

In a step 150 of the method 100, the permeability κ of the porous material is determined from the equation [Math. 5].

In the case of a hydrogel, the permeability is of the order of 10⁻¹² to 10⁻²⁰ m².

In the expression [Math. 4], the parameters H and S are geometric factors of the material. These factors can be corrected by numeric flow simulations if the geometry of the measuring device with the porous material is complex.

Hereinafter, examples of implementation of the method and of the device according to the invention will be described.

According to a first example, the permeability of the collagen is determined, for collagens of type IP and IA supplied by the company Nitta Gelatin, which corresponds to pig tendon gelatin respectively extracted enzymatically (pepsine) or chemically in acid medium.

The air cavity is connected to a tube 45 cm long and 3 mm in diameter, i.e. a total volume of 3.6 mL. In order to control the pressure in the cavity, a triangle signal of amplitude 1000 Pa and a period of 500 s repeated 10 times is applied in the tube. The sampling speed is 500 ms.

FIG. 6 shows a measurement of the flow rate q of collagen as a function of the pressure differential applied to the collagen matrix, for collagens of type IP (measurement points referenced 12) and IA (measurement points referenced 13). A hysteresis of the response according to the rise or drop in pressure in the air cavity can be observed for the two graphs. The data are averaged over 5 s for each point presented in the diagram.

In order to obtain a flow rate, the variation in pressure per unit time in the air cavity is multiplied by the volume of the cavity and the compressibility coefficient of air at atmospheric pressure. The flow rate is shown as a function of the pressure differential applied between the tube and the air cavity that is known by direct measurement in real time.

In the diagram in FIG. 6, the responses q(ΔP) were fitted with a fourth-order polynomial described in Rosti et al., “The Breakdown of Darcy's Law in a Soft Porous Material”, Soft Matter 16. 939-944 (2020) (solid lines). The permeation flow Q is a function of a fourth-order polynomial of the pressure difference ΔP):

$$Q ∝ {D}^{2} {φ}^{3} f ( Δ P ) , \qquad [ Math . 7 ]$$

with D the diameter of the pores of the material, φ its porosity and

$$f ( Δ P ) = \frac{1}{12} ( Δ P + \frac{3}{2} \frac{Δ {P}^{2}}{G} + \frac{Δ {P}^{3}}{{G}^{2}} + \frac{1}{4} \frac{Δ {P}^{4}}{{G}^{3}} ) \text{?} \qquad [ Math . 8 ]$$

$$\text{?} \text{indicates text missing or illegible when filed}$$

where G is the shear modulus of collagen.

The shear moduli measured are 2982 Pa and 4433 Pa, for the collagens IA and IP respectively.

According to a second example, the cell barrier of an endothelial tissue is characterised.

In this example, the collagen microchannel as described above is covered with a solution of human umbilical vein endothelial cells (HUVEC) at a concentration of 10 millions of cells per mL, twice during 5 min. The cells are next incubated for 1 to 3 days at 37° C. and 5% CO₂ in the incubator.

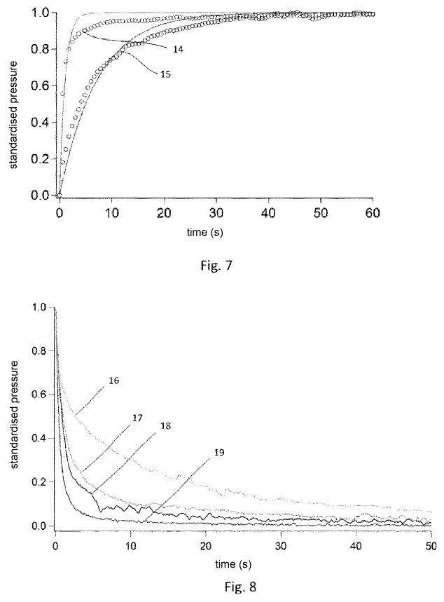

FIG. 7 shows the measurement of the pressure response P_{C}(t) in the air cavity after application of a pressure of 100 Pa in the microchannel with (measurement points referenced 15) or without (measurement points referenced 14) HUVEC cells. The measurement of the hydrodynamic resistance of the cell barrier is done by fitting the time response in pressure P_{C}(t) in the air cavity with the following equation:

$${P}_{C} = {P}_{B} ( 1 - e \text{?} ) \text{?} \qquad [ Math . 9 ]$$

$$\text{?} \text{indicates text missing or illegible when filed}$$

wherein τ is a time constant dependent on the permeability of the porous material and on the viscosity of the fluid. The fit is presented in solid lines in the diagram in FIG. 7. The fit to the curves 14 and 15 can be improved by integrating an elasticity of the material in the model, on the basis of the equation [Math. 6].

A more rapid pressure response in the case of collagen without cell barrier is observed on FIG. 7. This is because the cell barrier reduces the flow of fluid, which causes a slower rise in pressure in the air cavity.

According to a third example, the response of collagen matrix, which may be loaded or not with a fibroblast cells, is measured.

The concentrations of collagen used are 2.4 mg/mL, 1.9 mg/mL and 1.4 mg/mL. For the measurement with fibroblasts, the concentration of fibroblasts is 40 cells per μl of collagen diluted to a concentration of 2.4 mg/mL for a total volume of collagen of 30 μl. After 5 days of maturation, the collagen and the cells are fixed with paraformaldehyde at 4% by volume (PFA) for 30 min and then rinsed five times with deionised water.

The measurement of the pressure in the air cavity is made after pressurisation of the air cavity at 100 Pa. The pressure is next released in the collagen microchannel. A flow going from the cavity to the tube is then observed and, consequently, a drop in pressure in the cavity.

FIG. 8 shows the measurements of pressure discharge in the air cavity for collagen concentrations of 2.4 mg/mL with fibroblasts (graph 16), 2.4 mg/mL without fibroblasts (graph 17), 1.9 mg/mL (graph 18) and 1.4 mg/mL (graph 19). It appears that the kinetics of the discharge of the pressure in the air cavity depends on the concentration of collagen, as well as on the presence of fibroblasts in the matrix.

According to a fourth example, the mechanical response of a layer, or membrane, of collagen under a hydrostatic pressure force is characterised.

This characterisation is implemented with a measuring device in which the collagen can undergo deformations. It is for example implemented in a device as illustrated on FIG. 4, in which the layer of material is suspended by its lateral edges. In this case, the porous material is free to deform in the direction of the flow applied.

FIG. 9 shows a standardised pressure response in the air cavity using a layer of collagen after application of a pressure operation of 100 Pa. The collagen gel is manufactured according to the same method as in the third example 3.

It found that, at time t=0, the standardised pressure is greater than 0, unlike the curves shown on FIG. 7. This abrupt increase is due to the fact that the layer of collagen deforms immediately by buckling when it is subjected to a hydrostatic pressure. This mechanical deformation reduces the volume of the air cavity 4. As a buckling instability is determined by the modulus of elasticity of the material, the rapid jump makes it possible to access this modulus of elasticity. Next, the pressure field propagates in the material, which leads to a modification of the form of the top interface of the material in the cavity (determined by the Poisson's ratio) and a transfer of liquid through the material, both due to the permeation flow. This leads to a slower reduction in the volume of the cavity 4. The pressure in the cavity therefore increases according to both the deformation and the permeability of the material. These two mechanisms have very different timescales.

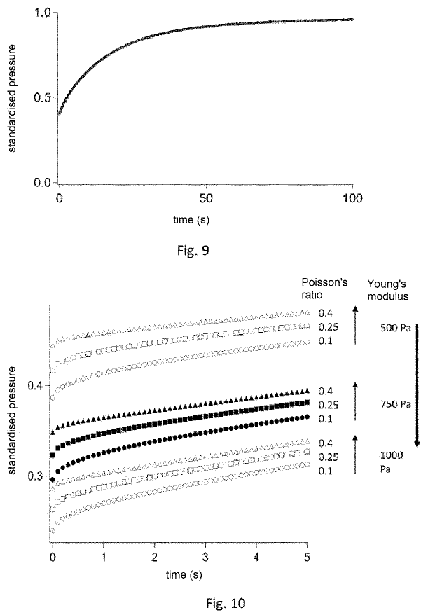

FIG. 10 shows an increase in the short time of the pressure response in the cavity for a model material simulated with the COMSOL software from the company COMSOL, where the properties of the material, in particular the Poisson's ratio and the Young's modulus, are varied. For three different Young's moduli shown, it is noted that the amplitude of the first pressure operation increases when the modulus of elasticity decreases, in other words when the buckling deformation increases. In addition, it is possible to measure the Poisson's ratio, which produces different curves for all the moduli of elasticity depending on whether its value is equal to 0.1, 0.25 or 0.4. This difference is explained by the change in the profile of the top layer of the collagen under the effect of the hydrostatic pressure.

In particular, in the case of a Poisson's ratio of 0.4, an abrupt transition is observed between the initial deformation and the kinetics that follows. When the Poisson's ratio is reduced, a more and more “softened” kinetics is observed. Structural reorganisations of the material, characterised by a lower Poisson's ratio, then cause an increase in the time necessary for achieving the same deformation as with a higher Poisson's ratio.

Naturally the invention is not limited to the examples that have just been described and numerous arrangements can be made to these examples without departing from the scope of the invention.

1. A device for measuring the permeability of a porous material to a fluid, the device comprising:
an air cavity of a specific volume;
a material module, the material module comprising:
a support configured to contain a volume of fluid, and
the porous material;
wherein the air cavity and the support are arranged so that a specific thickness H of the porous material is located between the volume of fluid and the air cavity, a wall of the air cavity being partially formed by the porous material;
the device furthermore comprising:
a pressure sensor for measuring the pressure P_{C} in the air cavity as a function of time;
a pressure controller for controlling the pressure of the volume of fluid configured to apply a fluid pressure P_{B} to the volume of fluid so as to cause a flow of fluid through the porous material into the air cavity;
a digital device configured to:
determine the pressure gradient between the volume of fluid and the air cavity,
$$∇ P = ( {P}_{B} - {P}_{C} ) / H ;$$
determine the flow rate of the fluid through the porous material from the drift over time in the pressure of the air in the cavity, dP_{C}/dt; and
determine the permeability of the porous material from the flow rate and from the pressure gradient ∇P.

2. The device according to claim 1, wherein the digital device is furthermore configured to determine the modulus of elasticity of the porous material from the pressure gradient between the volume of fluid and the air cavity, ∇P, as a function of time.

3. The device according to claim 1, wherein the pressure sensor for measuring the pressure comprise a remote pressure sensor connected to the air cavity.

4. The device according to claim 1, wherein the volume of fluid is contained partially in a microchannel passing through the porous material.

5. The device according to claim 1, wherein the support is made from polydimethylsiloxane, PDMS.

6. The device according to claim 1, wherein the air cavity is produced by 3D printing.

7. The device according to claim 1, wherein the porous material is glued to the support.

8. The device according to claim 1, wherein the porous membrane is disposed on the support removably.

9. A method for measuring the permeability of a material porous to a fluid, wherein a given thickness H of the porous material is arranged between an air cavity of a given volume and a volume of fluid, a wall of the air cavity being partially formed by the porous material, the method comprising the following steps:
applying a pressure P_{B} to the volume of fluid so as to cause a flow through the porous material into the air cavity;
measuring the pressure P_{C} in the air cavity as a function of time;
determining the pressure gradient between the volume of fluid and the air cavity, ∇P=(P_{B}−P_{C})/H;
determining the flow rate of the fluid through the porous material from the drift over time in the pressure of the air in the cavity, dP_{C}/dt; and
determining the permeability of the porous material from the flow rate and pressure gradient ∇P.

10. The method according to claim 9, furthermore comprising a step of determining the modulus of elasticity of the porous material from the pressure gradient between the volume of fluid and the air cavity, ∇P, as a function of time.

11. The method according to claim 9, wherein the step of measuring the pressure in the air cavity is implemented by means of a remote pressure sensor connected to the air cavity.

12. The method according to claim 9, wherein the step of measuring the pressure in the air cavity is implemented at regular intervals using the application of the pressure, P_{B}, and making it possible to follow the change in the flow rate of fluid over the whole of the range of pressure gradient values ∇P between P_{B}/H and 0.

13. The method according to claim 9, furthermore comprising a prior preparation phase, comprising the following steps:
providing a material support, the air cavity and the porous material, the support being configured to contain a volume of fluid;
applying a porous material to the support;
disposing the air cavity on the material;
providing a pressure sensor for measuring the pressure in the air cavity; and
providing a pressure controller for controlling the pressure of the volume of fluid..
